(19) United States
(12) Patent Application Publication
(10) Pub. No.: US 2013/0072061 A1
(43) Pub. Date: Mar. 21, 2013

(54) CONNECTOR

(71) Applicant: Satoshi Morikawa, Yokkaichi-City (JP)

(72) Inventor: Satoshi Morikawa, Yokkaichi-City (JP)

(73) Assignee: SUMITOMO WIRING SYSTEMS, LTD., Yokkaichi-City (JP)

(21) Appl. No.: 13/609,851

(22) Filed: Sep. 11, 2012

(30) Foreign Application Priority Data
Sep. 20, 2011 (JP) 2011-204812

(51) Int. Cl. H01R 13/40

(52) U.S. Cl. 439/587

(57) ABSTRACT

A terminal fitting (40) has a waterproof member (50) is mounted to cover a contact part between a wire barrel (42A) and a core (31) of a wire (30) from the wire barrel (42A) to an insulation barrel (42B). A peripheral wall (17) of the cavity (11) is formed with a locking lance (19) that is resiliently deformable in a width direction of the cavity (11) and retains the terminal fitting (40) by being engaged with the terminal fitting (40). A recess (22) for widening the width of the cavity (11) is formed in a part of the peripheral wall (17) formed with the locking lance (19) corresponding to the insulation barrel (42B). The barrel portion (42) of the terminal fitting (40) is bent that the insulation barrel (42B) projects toward the recess (22).

### BACKGROUND OF THE INVENTION

1. Field of the Invention. The invention relates to a connector.

2. Description of the Related Art. U.S. Pat. No. 6,824,428 discloses a conventional connector formed such that a terminal fitting fixed to an end portion of a wire is held in a housing by being inserted from behind into a cavity formed in the housing.

Aluminum cores have been used increasingly in recent years instead of conventional copper alloy cores for weight saving of automotive vehicles. On the other hand, terminal fittings made of copper alloy are used as terminal fittings in many cases to ensure sufficient strength when crimped and connected to cores of wires.

Resin sealing a connected part between a core of a wire and a terminal fitting can prevent the presence of moisture and hence can prevent the occurrence of electrolytic corrosion. However, a terminal fitting with the above-described anti-corrosion measure has a part to be connected to a wire that is larger than conventional terminal fittings. Thus, in a connector compatible with a conventional terminal fitting, there is a problem that a clearance of a cavity becomes insufficient and a resin-sealed part contacts the peripheral wall of the cavity to make the insertion of the terminal fitting difficult.

Accordingly, for a connector compatible with a terminal fitting provided with an anti-corrosion measure, it is thought to widen a cavity in conformity with the size of the terminal fitting. However, such widening of the cavity enlarges the connector. Mounting space for a larger connector may not be in a vehicle. Thinning the peripheral wall of cavity could widen the cavity without enlarging the connector. However, the thinning of the peripheral wall of the cavity may lead to a short circuit between terminal fittings and a deteriorated resin flow in molding a housing.

The invention was completed in view of the above situation and an object thereof is to allow a terminal fitting provided with an anti-corrosion measure to be inserted and to prevent a short circuit between terminal fittings and a deteriorated resin flow in molding a housing without being made larger than conventional connectors.

### SUMMARY OF THE INVENTION

The invention relates to a connector with a housing that has at least one cavity and at least one terminal fitting that can be inserted into the cavity. The terminal fitting includes a wire connection portion or barrel to be fixed to a core of a wire. A contact part between the wire connection portion and the core of the wire is covered by a fluidproof member. A peripheral wall of the cavity is formed with a locking lance that is resiliently deformable in a direction intersecting the insertion direction and retains the terminal fitting by engaging the terminal fitting. At least one recess is formed in a part of the peripheral wall formed with the locking lance and widens the cavity at a position corresponding to a part of the wire connection portion. The wire connection portion of the terminal fitting is bent so that the part of the wire connection portion projects toward the recess.

The recess forms a clearance that enables insertion of the terminal fitting provided with a fluid- proofing and/or anti-corrosion measure. Further, the recess in the peripheral wall of the cavity does not enlarge the connector. Additionally, the recess is limited to the part of the peripheral wall of the cavity corresponding to the part of the wire connection portion of the terminal fitting. Thus, a short circuit between terminal fittings and deteriorated resin fluidity in molding the housing caused by the thinned peripheral wall of the cavity can be prevented.

The recess is formed in the peripheral wall that has the locking lance. A deformation space needs to be secured laterally to the locking lance. Thus, the peripheral wall formed with the locking lance is allowed to have a larger thickness. Further, the wire connection portion of the terminal fitting is bent so that a part thereof projects toward the recess. Therefore, the cavity can be widened toward the peripheral wall. This configuration is advantageous in preventing a short circuit between terminal fittings and deteriorated resin fluidity in molding the housing caused by the thinned peripheral wall of the cavity.

The wire connection portion preferably includes a wire barrel to be fixed to the core of the wire and an insulation barrel to be fixed to an insulation coating of the wire.

The fluid-proof member preferably covers a contact part between the wire barrel and the core of the wire from the wire barrel to the insulation barrel.

The recess for widening the cavity preferably is formed in a part of the peripheral corresponding to the insulation barrel.

The locking lance preferably is resiliently deformable in a width direction of the cavity.

The locking lance may project in from an inner surface of the peripheral wall and the recess may be formed behind the locking lance to be recessed outwardly of the locking lance.

The waterproof member may be or may comprise a heat shrinking tube.

The terminal fitting preferably includes a connecting portion to be connected to a mating terminal fitting and a link linking the wire connection portion and the connecting portion. The fluidproof member preferably covers an outer side of the link.

The link may include a fluidproof portion for at least partly filling up a clearance between the link and the fluidproof member.

Further particularly, the recess is formed in a part corresponding to the fluid-proof portion, and/or wherein the linking portion comprises a base plate and a pair of side plates and wherein the fluidproof portion at least partly fills up a groove enclosed by the base plate and the pair of side plates.

Further particularly, at least one supporting portion for supporting a front end of a connecting portion of the terminal fitting to restrict the inclination of the terminal fitting in a resilient deforming direction of a locking lance is provided to project inwardly at a front end position of the cavity, wherein the supporting portion particularly is connected to both a front wall of the cavity and a side wall of the cavity.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is an enlarged side view partly in section of a housing of a connector according to the present invention showing the shape of a cavity.

FIG. 2 is an enlarged plan view partly in section of the housing showing the shape of the cavity.

FIG. 3 is a partial enlarged rear view of the housing showing the shape of the cavity.

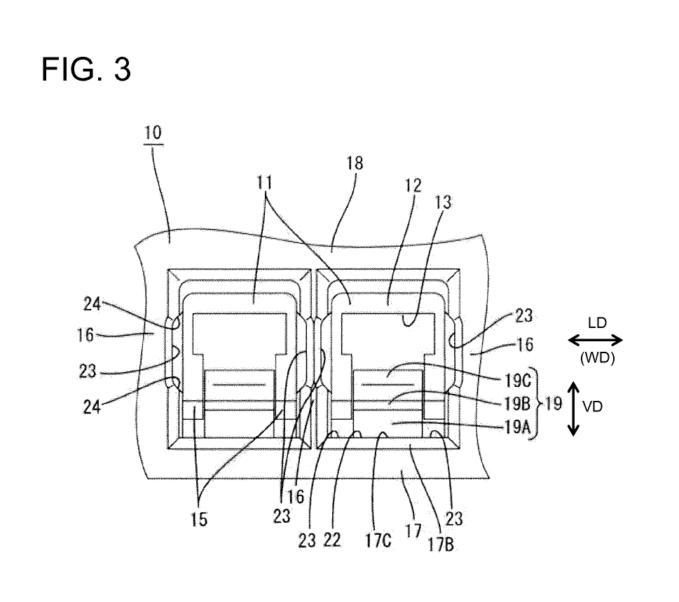

FIG. 4 is an enlarged side view partly in section of the connector showing a state where a terminal fitting is accommodated in the cavity.

FIG. 5 is an enlarged plan view partly in section of the connector showing the state where the terminal fitting is accommodated in the cavity.

FIG. 6 is a partial enlarged lateral section along A-A of FIG. 4 of the connector showing the state where the terminal fitting is accommodated in the cavity.

FIG. 7 is a partial enlarged lateral section along B-B of FIG. 4 of the connector showing the state where the terminal fitting is accommodated in the cavity.

### DETAILED DESCRIPTION OF THE PREFERRED EMBODIMENTS

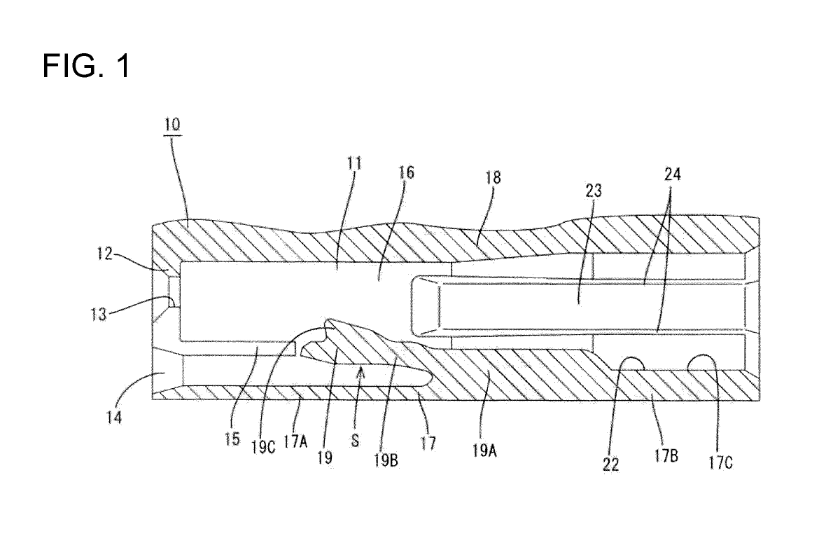

A female connector in accordance with the invention is identified by the letter C and has a housing 10 and cavities 11 formed in the housing 10. Female terminal fittings 40 fixed to ends of respective wires 30 are to be inserted from behind into the cavities 11 in the housing 10. The terminal fittings 40 are electrically conductively connectable to male terminal fittings held in an unillustrated mating connector to be connected to the housing 10. An inserting direction of the terminal fittings 40 into the housing 10 is referred to herein as a forward direction, and upper and lower sides of FIG. 1 are referred to as the top and bottom.

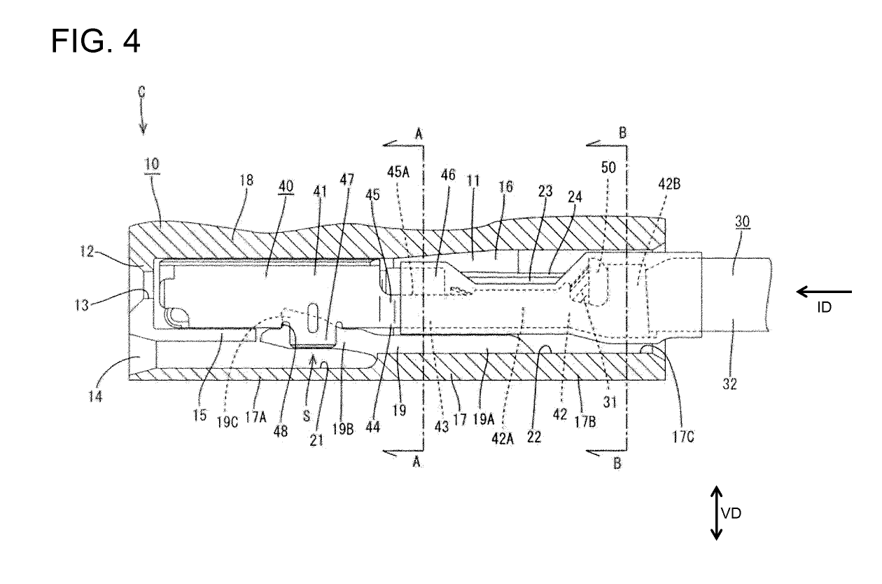

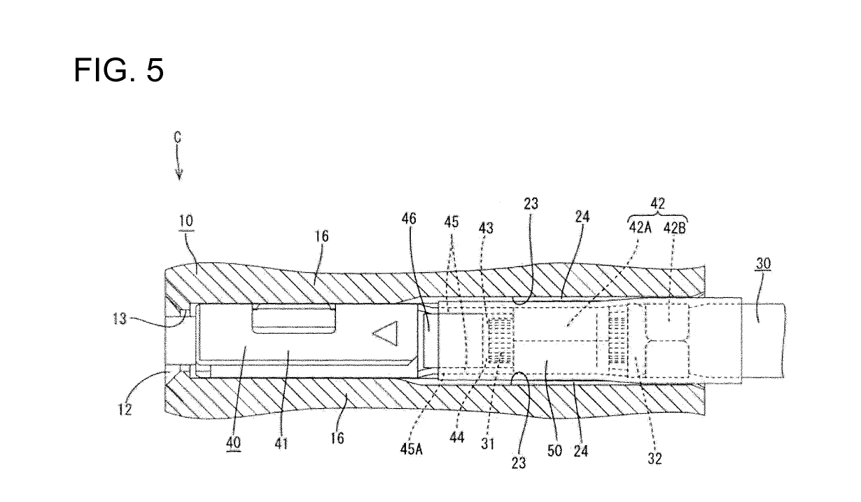

The wire 30 a core 31 formed by twisting a plurality of thin metal wires made of aluminum or aluminum alloy and an insulation coating 32 made e.g. of synthetic resin covers the outer periphery of the core 31. The insulation coating 32 is stripped over a specified length at the end of the wire 30 to expose the core 31 (see FIGS. 4 and 5). Note that the core 31 may be a single core wire.

The terminal fitting 40 includes a connecting portion 41 to be connected to an unillustrated mating terminal fitting, a wire barrel 42 to be connected to an end of the wire 30, and a link 43 linking the wire barrel 42 and the connecting portion 41. The terminal fitting 40 is formed by press-working a conductive plate material, such as copper or copper alloy, shaped to be long and narrow in forward and backward directions, and an unillustrated plating layer may be formed on the surface of the metal plate material. Tin, nickel or other metal as needed can be adopted as the plating layer. In this embodiment, a tin plating layer is formed on the surface of copper or copper alloy. Note that the plating layer may not be formed on the surface of the metal plate material.

The connecting portion 41 is a substantially rectangular tube and a tab of the mating male terminal fitting is to be inserted therein for connection. A base plate 44 extends in forward and backward directions behind the connecting portion 41 and the end portion of the wire 30 can be placed on the upper surface of the base plate 44.

The link 43 has two side plates 45 standing up from opposite lateral sides of the barrel 44 to define a U-shaped cross-section. The front and rear ends of the side plates 45 are continuous extensions of the connecting portion 41 and the wire barrel 42.

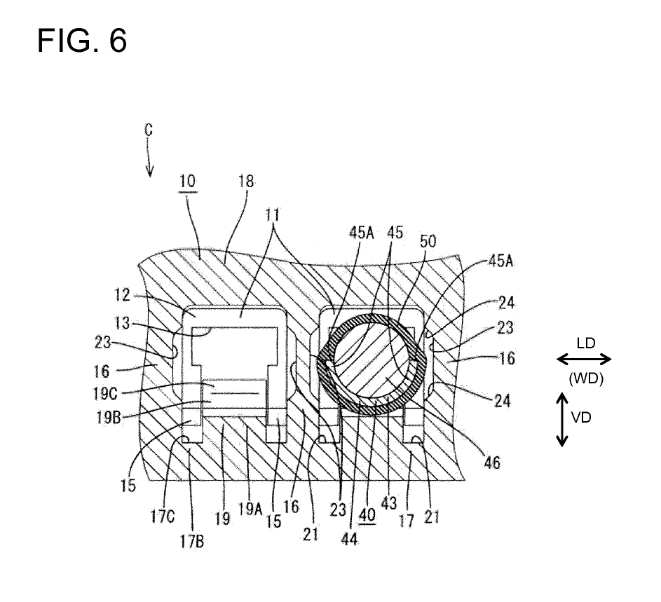

The link 43 is provided with a fluid- or waterproof portion 46 for filling a groove enclosed by the bottom plate 44 and the side plates 45 without leaving any substantial clearance (see FIG. 6). The waterproof portion 46 is formed by fitting a resin processed material into the link 43 and applying a curing or heating treatment so that the waterproof portion 46 projects up or out from end surfaces 45A of the side plates 45.

The barrel 42 has an insulation barrel 42B to be crimped, folded or deformed into connection with an end of the insulation coating 32 and a wire barrel 42A to be crimped, folded or deformed into connection with the end of the core 31.

The wire barrel 42A initially is an open barrel with barrel pieces projecting from opposite lateral sides of the arcuate bottom plate 44 while substantially facing each other. The wire barrel 42A embraces or surrounds the core 31 from an outer side and bites into the core 31 while projecting edges of the barrel pieces are butted against each other to define a substantially heart shape. At least one (unillustrated) serration is formed on the inner surface of the wire barrel 42A.

The insulation barrel 42B also is likewise in the form of an open barrel with barrel pieces projecting from opposite lateral sides of the arcuate bottom plate 44 while substantially facing each other. The insulation barrel 42B is crimped, folded or deformed and connected while at least partly embracing the end of the insulation coating 32. The bottom plate 44 of the insulation barrel 42B is slightly larger than the bottom plate 44 of the wire barrel 42A and the barrel pieces of the insulation barrel 42B are narrower and longer in height than those of the wire barrel 42A.

A contact part between the barrel 42 and the core 31 of the wire 30 is covered by a heat shrinking tube 50. The heat shrinking tube 50 is made e.g. of a synthetic resin that shrinks when subjected to a heating treatment and has a tubular shape capable of covering from the link 43 of the terminal fitting 40 to the end portion of the insulation coating 32 of the wire 30 to a position behind the insulation barrel 42B. An adhesive layer (not shown) made e.g. of a thermoplastic adhesive which exhibits an adhesive property by being softened or melted by heat is provided on the inner peripheral surface of the heat shrinking tube 50.

The heat shrinking tube 50 is to be arranged to at least partly cover the connected part between the wire 30 and the terminal fitting 40 in an unheated state after the terminal fitting 40 is fixed to the end portion of the wire 30. Thereafter, the heat shrinking tube 50 shrinks by being irradiated or heated by an unillustrated heating apparatus and the adhesive layer on the inner peripheral surface thereof is melted to adhere tightly to the outer peripheral surface of the connected part between the terminal fitting 40 and the wire 30.

In the state covered by the heat shrinking tube 50, a rear part of the terminal fitting 40, excluding the connecting portion 41, is slightly larger than the parts not provided with an anti-corrosion measure. At the position of the fluid- or waterproof portion 46, the width is largest at boundaries between the outer peripheral surfaces of the waterproof portion 46 and the link 43 (end surfaces 45A of the side plates 45 of the link 43), as shown in FIG. 6. Thus, the width is larger in a lateral direction LD than in a vertical direction VD at the fluid- or waterproof portion 46.

Cavities 11 are provided substantially side by side in the housing 10 and the terminal fittings 40 can be inserted into the cavities 11 from behind. An arrangement pitch between the cavities 11 is the same as that of cavities of a connector compatible with conventional terminal fittings with no anti-corrosion measure so that the connection to the existing mating connector is possible.

A front part of the cavity 11 has a width in the lateral direction that conforms to the width of the connecting portion 41 in the lateral direction LD and an appropriate clearance.

The cavity 11 has a front wall 12 that stops forward movement of the terminal fitting 40 inserted into the cavity 11 (see FIG. 4). This front wall 12 has a tab insertion hole 13 for receiving the tab of the mating terminal fitting inserted from the front. Further, a mold removal hole 14 is formed in a part of the front wall 12 below the tab insertion hole 13 and enables forward removal of a front mold for forming a locking lance 19.

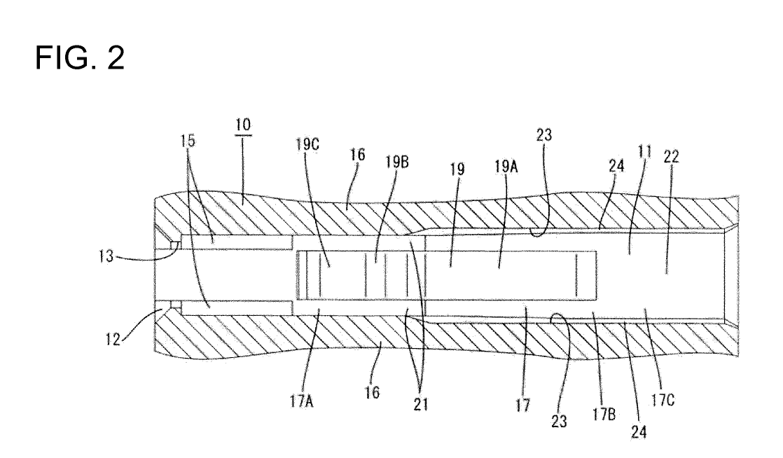

Supports 15 project in at both corners of the front end of the cavity 11 for supporting the front end of the connecting portion 41 of the terminal fitting 40 and to restrict inclination of the terminal fitting 40 in the vertical direction VD (resilient deforming direction of the locking lance 19). The supports 15 are connected to both the front wall 12 of the cavity 11 and a side wall 16 of the cavity 11, as shown in FIG. 2, to increase strength. A distance between the supports 15 and an upper wall 18 of the cavity 11 conforms to the width of the connecting portion 41 in the vertical direction (see FIG. 4).

A front part of a lower wall 17 of each cavity 11 is slightly lower than a rear part thereof. The front part of the lower wall 17 is referred to hereinafter as a lower portion 17A and the rear part is referred to as a higher portion 17B. A front part of the upper wall 18 of each cavity 11 is substantially parallel to the lower portion 17A of the lower wall 17, an intermediate part is inclined to slightly widen the width of the cavity 11 in the vertical direction toward the back, and a rear part is substantially parallel to the higher portion 17B.

The lower wall 17 of the cavity 11 has the locking lance 19 for locking and retaining the terminal fitting 40. The locking lance 19 projects in from an inner surface 17C of the lower wall 17 of the cavity 11.

The locking lance 19 has a base 19A that is formed unitarily to the higher portion 17B and is located above the higher portion 17B. A resilient displacing portion 19B is cantilevered forward from the base 19A and is above the lower portion 17A.

The thickness of the base 19A in the vertical direction VD is substantially constant, but the rear end surface of the base 19A is inclined gradually down toward the back.

The resilient displacing portion 19B is inclined gradually in or up toward the front to project into the cavity 11. A lock 19C projects into an insertion path for the terminal fitting 40 and is pressed by the connecting portion 41 of the terminal fitting 40 to deform the resilient displacing portion 19B out or down in a direction crossing inserting and withdrawing directions of the terminal fitting 40 with the base 19A as a supporting point. The resilient displacing portion 19B is retracted into a deformation space S between itself and the lower wall 17 of the lower portion 17A during this resilient deformation.

As shown in FIG. 2, the locking lance 19 is substantially in the widthwise center of the lower wall 17 and has a constant width over the entire length. Grooves 21 are formed at the opposite sides of the locking lance 19. The grooves 21 are surrounded by the locking lance 19, the lower wall 17 and the side walls 16. Stabilizers 47 can be inserted into the grooves 21 for guiding insertion of the terminal fitting 40.

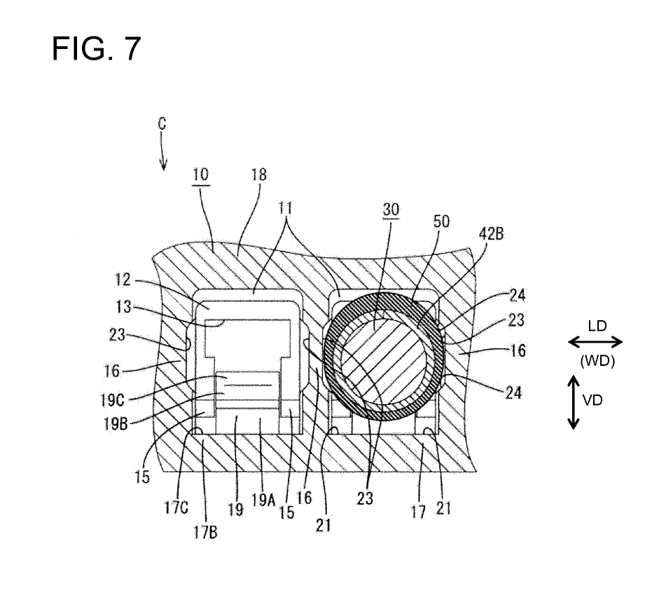

Escaping portions 23 are formed in parts of the side walls 16 of the cavity 11 to widen the cavity 11 in the width direction WD or lateral direction LD at a location corresponding to the barrel 42 of the terminal fitting 40 so that these parts are recessed with respect to other parts (see FIGS. 6 and 7). As shown in FIG. 1, the escaping portion 23 is long and narrow in forward and backward directions when viewed sideways and extends from a position slightly before the fluid- or waterproof portion 46 to the rear end of the cavity 11. The dimension of the escaping portion 23 in a vertical direction VD or a direction intersecting the width direction WD or lateral direction LD is substantially constant in its entirety and the end surface 45A of the side plate 45 of the link 43 is substantially in the center thereof in the vertical direction VD, as shown in FIG. 6. The escaping portions 23 are on the opposite side surfaces of the side wall 16 between the adjacent cavities 11.

As shown in FIG. 2, the side walls 16 of the cavity 11 are substantially parallel to each other in a front part and incline slightly to widen the cavity 11 laterally toward the back in a rear part. In this way, the depth of the escaping portions 23 is reduced gradually toward the back. Note that front end parts of the escaping portions 23 are inclined to reduce the depth gradually toward the front.

The escaping portions 23 are shaped in conformity with the outer shape of the barrel 42. Specifically, the cross-sectional shape of the barrel 42 is substantially circular and the outer shape of the heat shrinking tube 50 mounted on the terminal fitting 40 also is substantially circular. Thus, inclined surfaces 24 are provided on the upper and lower ends of the escaping portions 23 and substantially conform to the outer shape of the heat shrinking tube 50 mounted on the terminal fitting 40 (see FIG. 7). The upper and lower inclined surfaces 24 are oblique so that a distance therebetween gradually increases toward the inside of the cavity 11.

A part of the lower wall 17 formed with the locking lance 19 corresponding to the insulation barrel 42B is formed with a recess 22 for widening the cavity 11 in the vertical dimension (see FIG. 4). The recess 22 is below and outside of the insulation barrel 42B and prevents the insulation barrel 42B from hindering insertion of the terminal fitting 40 by contacting the upper wall 18 or the lower wall 17 of the cavity 11. The recess 22 is provided behind the locking lance 19 and is recessed to be lower than the base portion 19A of the locking lance 19, and a recessed dimension thereof is equal to the height of the base 19A. The inner surface 17C of the higher portion 17B is a substantially flat surface except at the base 19A of the locking lance 19 and extends substantially continuously from the recess 22 to the grooves 21 without forming any step.

The barrel 42 is bent so that the insulation barrel 42B projects toward the recess 22. Specifically, as shown in FIG. 4, the bottom plate 44 of the barrel 42 is bent between the insulation barrel 42B and the wire barrel 42A to such an extent that the upper ends of the insulation barrel 42B and the fluid- or waterproof portion 46 are arranged at substantially the same height. Thus the bottom plate 44 of the insulation barrel 42B is slightly lower than the bottom plate 44 of the wire barrel 42A.

The terminal fitting 40 is inserted into the cavity 11 from behind. Thus, the connecting portion 41 is inserted into the cavity 11 first and then the fluid- or waterproof portion 46 is inserted into the cavity 11. The escaping portions 23 formed in the side walls 16 of the cavity 11 ensure that the fluid- or waterproof portion 46 is inserted smoothly forward without the opposite side surfaces thereof being pressed against the side walls 16.

The wire barrel 42A and the insulation barrel 42B then are inserted into the cavity 11. The cavity 11 has a sufficient clearance for the wire barrel 42A, so that the wire barrel 42A moves smoothly forward.

The escaping portions 23 formed in the side walls 16 of the cavity 11 ensure that the insulation barrel 42B moves smoothly moves forward without the opposite side surfaces thereof being pressed against the side walls 16. Further, a downward projecting part of the insulation barrel 42B is arranged in the recess 22 so that the insulation barrel 42B is inserted smoothly into the cavity 11 and can be accommodated in a rear end part of the cavity 11 without the upper or lower end thereof being pressed strongly against the upper wall 18 or the lower wall 17 of the cavity 11.

The locking lance 19 is pressed by the connecting portion 41 of the terminal fitting 40 and deforms into the deformation space S. However, the locking lance 19 resiliently restores when the terminal fitting 40 is inserted to a proper depth into the cavity 11. As a result, the lock 19C engages an engaging portion 48 of the connecting portion 41 to retain the terminal fitting 40.

Each terminal fitting 40 includes the wire barrel 42A to be fixed to the core 31 of the wire 30 and the insulation barrel 42B to be fixed to the insulation coating 32 of the wire 30. The heat shrinking tube 50 is mounted to cover the contact part between the wire barrel 42A and the core 31 of the wire 30 from the wire barrel 42A to the insulation barrel 42B. The lower wall 17 of the cavity 11 is formed with the locking lance 19 that is resiliently deformable in a direction intersecting the insertion direction ID of the terminal fitting 40 into the cavity 11 and retains the terminal fitting 40 by being engaged therewith. The recess 22 for widening the cavity 11 is formed in the part of the lower wall 17 formed with the locking lance 19 and at a position corresponding to the insulation barrel 42B. The barrel 42 of the terminal fitting 40 is bent so that the insulation barrel 42B projects toward the recess 22.

A clearance is formed at the wide part of the terminal fitting 40 where the insulation barrel 42B is covered by the heat shrinking tube 50 so that the terminal fitting 40 with the fluid-proofing or anti-corrosion measure can be inserted. Further, the cavity 11 is widened by forming the recess 22 in the lower wall 17 of the cavity 11 so that the connector C is not enlarged. Furthermore, the recess 22 is limited to the part of the lower wall 17 of the cavity 11 corresponding to the insulation barrel 42B of the terminal fitting 40. Thus, a short circuit between the terminal fittings 40 is not likely and resin can flow properly for molding the peripheral walls of the cavities 11. Accordingly, the terminal fittings 40 with the fluid-proofing and/or anti-corrosion measure can be inserted easily, a short circuit between the terminal fittings 40 is not likely and deteriorated resin fluidity in molding the housing 10 is prevented without enlarging the connector C.

The recess 22 is formed in the wall of the cavity that has the locking lance 19. The deformation space S is needed for the locking lance 19. Thus, the wall 17 with the locking lance 19 must be thicker. Further, since the barrel 42 of the terminal fitting 40 is bent so that the insulation barrel 42B projects toward the recess 22. Thus, the cavity 11 is widened toward the lower wall 17 instead of being widened toward the upper wall 18. Therefore, the connector C prevents both a short circuit between the terminal fittings 40 and deteriorated resin fluidity in molding the housing 10 caused by the thinned peripheral walls of the cavities 11.

The invention is not limited to the above described embodiment. For example, the following embodiments also are included in the scope of the invention.

The female connector C with female terminal fittings 40 has been illustrated, but the invention is also applicable to male connectors with male terminal fittings.

The core 31 of the wire 30 is made of aluminum or aluminum alloy and the terminal fitting 40 is made of copper or copper alloy in the above embodiment. However, the core of the wire and the terminal fitting are not limited to these metals and can be made of the same metal if the outer shape becomes one size larger by waterproofing the connected part between them.

The waterproof portion 46 is formed by fitting the resin processed material into the groove of the link 43 and applying a heating treatment in the above embodiment. However, the fluid- or waterproof portion may be formed by molding a synthetic resin or the fluid- or waterproof portion may not be provided. In the case of no fluid- or waterproof portion, the formation range of the escaping portions can be smaller and the escaping portions may be formed only in parts corresponding to the insulation barrel.

The fluid- or waterproof member is the heat shrinking tube 50 in the above embodiment. However, the fluid- or waterproof member may be an elastic tube having rubber elasticity. Further, a sheet-like waterproof tape may be wound in an area from the fluid- or waterproof portion to the end portion of the insulation coating or a resin mold may be mounted.

The depth of the escaping portion 23 is reduced gradually toward the back in the above embodiment. However, the depth of the escaping portion may be substantially constant in its entirety or may be increased gradually toward the back.

The escaping portions 23 are provided in both side walls 16 of the cavity 11 in the above embodiment. However, the escaping portion may be provided in the upper wall of the cavity or may be provided in only one of the both side walls of the cavity depending on the shapes of the barrel and the fluid- or waterproof member.

What is claimed is:

1. A connector (C), comprising:
a housing (10) including at least one cavity (11) extending along an insertion direction (ID), a locking lance (19) formed on a peripheral wall (17) of the cavity (11) and being resiliently deformable in a direction intersecting the insertion direction (ID), at least one recess (22) formed in a part of the peripheral wall (17) that has the locking lance (19) and widening the cavity (11); and
at least one terminal fitting (40) configured for insertion into the cavity (11) along the inserting direction (ID) and for locked engagement by the locking lance (19) when inserted completely in the cavity (11), the terminal fitting (40) including a wire connection portion (42) fixed and connected to a core (31) of a wire (30) and a fluid-proof member (50) covering a contact part between the wire connection portion (42) and the core (31) of the wire (30), the wire connection portion (42) of the terminal fitting (40) being bent so that a part (42B) of the wire connection portion (42) projects toward the recess (22).

2. The connector of claim 1, wherein the wire connection portion (42) includes a wire barrel (42A) fixed to the core (31) of the wire (30) and an insulation barrel (42B) fixed to an insulation coating (32) of the wire (30).

3. The connector of claim 2, wherein the fluid-proof member (50) is mounted to cover a contact part between the wire barrel (42A) and the core (31) of the wire (30) from the wire barrel (42A) to the insulation barrel (42B).

4. The connector of claim 3, wherein the at least one recess (22) for widening the width of the cavity (11) is formed in a part of the peripheral wall (17) corresponding to the insulation barrel (42B).

5. The connector of claim 1, wherein the locking lance (19) is resiliently deformable in a width direction (VD) of the cavity (11).

6. The connector of claim 1, wherein the locking lance (19) projects in from an inner surface of the peripheral wall (17) and the recess (22) is formed behind the locking lance (19) and is recessed outwardly of the locking lance (19).

7. The connector of claim 1, wherein the fluid-proof member (50) comprises a heat shrinking tube.

8. The connector of claim 1, wherein the terminal fitting (40) includes a connecting portion (41) to be connected to a mating terminal fitting and a link (43) linking the wire connection portion (42) and the connecting portion (41), the fluidproof member (50) covering at least part of an outer side of the link (43).

9. The connector of claim 8, wherein the link (43) includes a fluidproof portion (46) for at least partly filling up a clearance between the link (43) and the fluidproof member (50).

10. The connector of claim 9, wherein the recess (23) is formed in a part corresponding to the fluidproof portion (46).

11. The connector of claim 9, wherein the link (43) comprises a base plate (44) and two side plates (45) and wherein the fluidproof portion (46) at least partly filling a groove enclosed by the base plate (44) and the side plates (45).

12. The connector of claim 1, wherein the housing (10) further includes at least one support (15) projecting in at a front end of the cavity (11) and supporting a front end of a connecting portion (41) of the terminal fitting (40) to restrict the inclination of the terminal fitting (40) in a resilient deforming direction of a locking lance (19), wherein the support (15) is connected to both a front wall (12) of the cavity (11) and a side wall (16) of the cavity (11).

13. A connector (C), comprising:
a housing (10) having opposite front and rear ends spaced apart along an insertion direction (ID), at least one cavity (11) extending along the insertion direction (ID) from the rear end to the front end, a locking lance (19) cantilevered forward along a peripheral wall (17) of the cavity (11) and being resiliently deformable in a direction intersecting the insertion direction (ID), at least one recess (22) formed in the peripheral wall (17) that has the locking lance (19), the recess (22) extending from the rear end of the housing (10) toward the locking lance (19); and
at least one terminal fitting (40) configured for insertion into the cavity (11) along the inserting direction (ID) and for locked engagement by the locking lance (19) when inserted completely in the cavity (11), the terminal fitting (40) including a wire connection portion (42) fixed and connected to a core (31) of a wire (30) and a fluid-proof member (50) covering a contact part between the wire connection portion (42) and the core (31) of the wire (30), the wire connection portion (42) of the terminal fitting (40) being bent so that a part (42B) of the wire connection portion (42) projects into the recess (22).

14. The connector of claim 13, wherein the wire connection portion (42) includes a wire barrel (42A) fixed to the core (31) of the wire (30) and an insulation barrel (42B) fixed to an insulation coating (32) of the wire (30).

15. The connector of claim 14, wherein the fluid-proof member (50) is mounted to cover a contact part between the wire barrel (42A) and the core (31) of the wire (30) from the wire barrel (42A) to the insulation barrel (42B).

16. The connector of claim 15, wherein the at least one recess (22) is formed in a part of the peripheral wall (17) corresponding to the insulation barrel (42B).
